(19) United States
(12) Patent Application Publication
(10) Pub. No.: US 2023/0214557 A1
(43) Pub. Date: Jul. 6, 2023

(54) METHOD FOR DYNAMICALLY ASSESSING SLOPE SAFETY

(71) Applicant: INSTITUTE OF MECHANICS, CHINESE ACADEMY OF SCIENCES, Beijing (CN)

(72) Inventors: Chun FENG, Beijing (CN); Xinguang ZHU, Beijing (CN); Pengda CHENG, Beijing (CN); Yu ZHOU, Beijing (CN); Lixiang WANG, Beijing (CN); Yongbo FAN, Beijing (CN); Li ZHANG, Beijing (CN)

(73) Assignee: INSTITUTE OF MECHANICS, CHINESE ACADEMY OF SCIENCES, Beijing (CN)

(21) Appl. No.: 18/089,590

(22) Filed: Dec. 28, 2022

(30) Foreign Application Priority Data
Dec. 30, 2021 (CN) 202111651736.1

(51) Int. Cl. G06F 30/27

(52) U.S. Cl. CPC G06F 30/27; G06F 2111/10

(57) ABSTRACT

A method for dynamically assessing slope safety includes the following steps: S1, carrying out geologic model generalization to the slope according to slope type, slope structure, stratum characteristics and a deformation failure mode to obtain a slope geologic model, creating a slope geometric model according to the slope geologic model, carrying out the subdivision of computational grid, and selecting a reasonable numerical simulation method, mechanical constitutive and initial boundary value conditions to form a computational model; and S2, adjusting stratum parameters, structural plane parameters and activating factor strength based on the computational model, carrying out a large amount of numerical simulation, summarizing results of the numerical simulation, normalizing input quantities and output quantities to establish machine learning samples. The method is able to dynamically adjust the geomechanical input parameters by using the monitoring data, making the prediction accuracy further higher, and can further achieve the real-time prediction.

### CROSS REFERENCE TO THE RELATED APPLICATIONS

This application is based upon and claims priority to Chinese Patent Application No. 202111651736.1, filed on Dec. 30, 2021, the entire contents of which are incorporated herein by reference.

### TECHNICAL FIELD

The present invention relates to technical fields of slope safety, and particularly to a method for dynamically assessing slope safety.

### BACKGROUND

The gestation, development, evolution, and disaster process of the landslide disaster are accompanied by changes in large amount of macroscopically measurable physical information, such as surface displacement, deep displacement, surface dip, pore water pressure, water content of geological bodies, etc. By capturing the above physical information in real time, it is possible to establish a mapping relation between the physical information and the evolution stage of the landslide disaster, which further provides the necessary basic data for the scientific early warning of the landslide. With the development of sensing technology, information technology and Internet of Things technology, it has been relatively mature to acquire the information such as deformation, stress, water level, pore pressure and the like on the surface and inside of the slope in real time with the help of various types of automatic monitoring equipment. However, as the monitoring data accumulates, how to carry out accurate assessment on the slope safety based on the monitoring data and slope characteristics is a common problem that the current academic and industrial circles face.

At present, the common practice is to carry out fitting and deduction based on limited data, such as Saito model, gray prediction theory, three-stage displacement model, etc. These methods are all mathematical methods, which carry out data analysis to reasonably extrapolate the evolution law of future monitoring point displacement (or other physical quantities). However, such methods do not take into consideration the influence of geological structure, slope characteristics, activating factors and the like on the law of development and evolution of the disaster. Therefore, the analysis method purely based on the monitoring data has relatively large limitations, and is generally only applicable to the internal cause-dominated critical landslide forecast, that is, the landslide has already started at this time, and would lead to the disaster due to the internal cause (such as gravity) without any external factors.

In recent years, with the development of artificial intelligence, the method of early warning and analysis of landslide disaster using the AI technology and the big data analysis technology has gradually formed. The core of AI is to create an embedded analysis model and model parameters using a large number of sampling cases, and then provide predictive analysis. However, for the landslide disaster, the effective sampling cases are extremely lacking. It is because the so-called effective sampling case needs to track the whole life cycle of the landslide disaster, that is, the monitoring information on occurrence, development, evolution and stop process of the landslide is complete. With the development of computer technology, the numerical simulation technology based on mechanical theory has played an important role in the optimization design of engineering slope, the stability analysis of natural slope, the assessment of the range of slope disaster, etc. At present, the underlying mechanical algorithms used in the numerical simulation have been relatively mature, but due to the heterogeneity of geological bodies and the limitation in survey costs, it is impossible to accurately acquire the physical and mechanical parameters at each site of the geological body, which affects the analysis and prediction accuracy of the numerical simulation. In addition, the numerical simulation often takes a long time, for example, hours or days are often needed in one simulation, which greatly limits the application of numerical simulation to the rapid predictive analysis of slope safety.

### SUMMARY

The object of the present invention is to provide a method for dynamically assessing slope safety, so as to solve the technical problem that the underlying mechanical algorithms used in the numerical simulation in the conventional technology have been relatively mature, but due to the heterogeneity of geological bodies and the limitation in survey costs, it is impossible to accurately acquire the physical and mechanical parameters at each site of the geological body, which affects the analysis and prediction accuracy of the numerical simulation; and in addition, the numerical simulation often takes a long time, for example, hours or days are often needed in one simulation, which greatly limits the application of numerical simulation to the rapid predictive analysis of slope safety.

In order to solve the above technical problems, the present invention specifically provides the following technical solutions:

A method for dynamically assessing slope safety, including:

step S1, carrying out geologic model generalization to the slope according to slope type, slope structure, stratum characteristics and a deformation failure mode to obtain a slope geologic model, creating a slope geometric model according to the slope geologic model, carrying out the subdivision of computational grid, and selecting a reasonable numerical simulation method, mechanical constitutive and initial boundary value condition to form a computational model;

step S2, adjusting stratum parameters, structural plane parameters and activating factor strength based on the computational model, carrying out a large amount of numerical simulation, summarizing results of the numerical simulation, normalizing input quantities and output quantities to create machine learning samples, and randomly dividing the learning samples into a sample A for machine learning and a sample B for machine prediction;

step S3, carrying out neural network selection and initialization settings, including determining the number of neurons at input and output terminals, determining the number of hidden layers and the number of neurons in each layer, selecting an activating function and an initial value of the weight coefficient, inputting the sample A to the neural network for learning, adjusting and optimizing transfer coefficients between neurons of the respective layers in the neural network to form a first surrogate model for slope safety prediction, and then inputting the sample B to the first surrogate model for prediction verification, and further adjusting the weight coefficient in the first surrogate model to form a second surrogate model for slope safety prediction with high reliability;

step S4, based on the geomechanical parameters in the initial state, inputting the activating factor data monitored on site of the slope into the second surrogate model, calculating the deformation failure situation of the slope, comparing the surface and internal mechanical response monitoring data of the slope with the calculation data of the corresponding positions in the second surrogate model to dynamically adjust the geomechanical parameters of the respective positions in the second surrogate model; and inputting the adjusted geomechanical parameters into the second surrogate model again to calculate the deformation failure situation of the slope and the disaster process; and

step S5, repeating step S4 to realize the dynamic assessment of future slope safety.

As a prderred solution of the present invention, the slope type includes rocky slope, soil slope, and bedrock and overburden slope, the slope structure includes a bedding structure, an anti-dip structure, a blocky structure, a loose structure, and a soil-rock mixture structure, the deformation failure mode includes slipping landslide, toppling failure, and collapse failure.

As a preferred solution of the present invention, the computational grid includes two-dimensional triangle, quadrilateral, polygon and disk grids, and three-dimensional tetrahedron, triangular prism, pyramid, hexahedron, polyhedron, and sphere grids.

As a preferred solution of the present invention, the numerical simulation method includes a finite element method, a finite volume method, a finite difference method, a block discrete element method, a particle discrete element method, and a meshless method.

As a preferred solution of the present invention, the mechanical constitutive includes Drucker-Prager constitutive, Mohr-Coulomb constitutive, Hoek-Brown constitutive, ubiquitous joint constitutive, and fracture energy constitutive.

As a preferred solution of the present invention, the geomechanical parameters include density, elastic modulus, Poisson's ratio, cohesion, internal friction angle, tensile strength, dilatancy angle, tensile fracture energy, and shear fracture energy.

As a preferred solution of the present invention, the neural network includes a forward neural network and a feedback neural network, the forward neural network includes a single-layer perceptron, multi-layer perceptron, back propagation (BP) neural network, and the feedback neural network includes Hopfield, Hamming, Bidirectional Associative Memory (BAM) network.

As a preferred solution of the present invention, the activating factor includes rainfall, reservoir water or groundwater fluctuations, earthquakes, manual excavation, and engineering blasting disturbances.

As a preferred solution of the present invention, the dynamic assessment of slope safety includes stability assessment and disaster risk assessment.

As a preferred solution of the present invention, the inversion method of geomechanical parameters in slope current state includes a gradient descent method, a conjugate gradient method, and a Newton method.

Compared with the conventional technologies, the present invention has the following beneficial effects.

The present invention combines on-site monitoring data, numerical simulation analysis and neural network prediction, creates geometric model and computational grid according to the slope type, provides samples for machine learning through a large number of numerical simulations, carries out deep learning with the help of the neural network to form the surrogate model for real-time prediction of the slope safety, carries out dynamic inversion on the geomechanical parameters in the surrogate model using the monitoring data to form accurate geomechanical input parameters of the current state, and inputs the adjusted geomechanical parameters into the surrogate model to dynamically assess the future slope safety. Compared with the conventional slope safety prediction model based only on the monitoring data, the present invention has higher prediction accuracy and is able to analyze and predict the range of the slope disaster. Compared with the conventional numerical simulation analysis, the present invention is able to dynamically adjust the geomechanical input parameters by using the monitoring data, making the prediction accuracy further higher, and can further achieve the real-time prediction due to the use of the surrogate model created by the neural network.

### BRIEF DESCRIPTION OF THE DRAWINGS

In order to illustrate the embodiments of the present invention or the technical solutions in the conventional technologies more clearly, the accompanying drawings required to be used in the description of the embodiments or the conventional technologies will be briefly described. Obviously, the drawings described below are merely exemplary, and can be fUrther used to derive other implementation drawings by those skilled in the art without any creative efforts.

FIG. 1 is a flowchart of the method for dynamically assessing slope safety provided by an embodiment of the present invention;

FIG. 2 is a flowchart of the slope safety assessment provided by the embodiment of the present invention;

FIG. 3 is a flowchart of the numerical simulation for slope safety provided by the embodiment of the present invention;

FIG. 4 is a flowchart of learning and prediction based on the neural network provided by the embodiment of the present invention;

FIG. 5 is a flowchart of the inversion of geomechanical parameters in the current state of the slope provided by the embodiment of the present invention;

FIG. 6 is a diagram showing a generalized geological model of a certain bedding rock slope provided by the embodiment of the present invention; and

FIG. 7 is a diagram showing a generalized geological model of a certain bedrock and overburden slope provided by the embodiment of the present invention.

### DETAILED DESCRIPTION OF THE EMBODIMENTS

The technical solutions in the embodiments of the present invention are described clearly and completely with reference to the drawings of the embodiments of the present invention below. Obviously, the described embodiments are merely part, not all, of the present invention. Any other embodiments achieved based on the embodiments of the present invention by those skilled in the art without any creative efforts shall fall within the protection scope of the present invention.

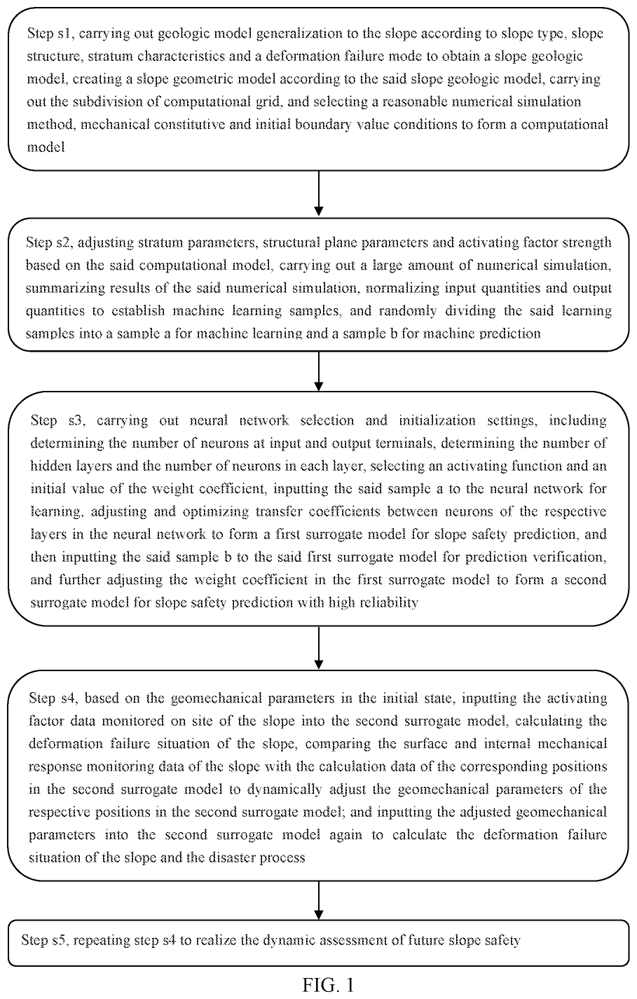

As shown in FIG. 1, the present invention provides a method for dynamically assessing slope safety, including the following steps.

Step S1, carrying out geologic model generalization to the slope according to slope type, slope structure, stratum characteristics and a deformation failure mode to obtain a slope geologic model, creating a slope geometric model according to the slope geologic model, carrying out the subdivision of computational grid, and selecting a reasonable numerical simulation method, mechanical constitutive and initial boundary value conditions to form a computational model.

The slope type includes rocky slope, soil slope, and bedrock and overburden slope, the slope structure includes a bedding structure, an anti-dip structure, a blocky structure, a loose structure, and a soil-rock mixture structure, the deformation failure mode includes slipping landslide, toppling failure, and collapse failure.

The computational grid includes two-dimensional triangle, quadrilateral, polygon and disk grids, and three-dimensional tetrahedron, triangular prism, pyramid, hexahedron, polyhedron, and sphere grids.

The numerical simulation method includes a finite element method, a finite volume method, a finite difference method, a block discrete element method, a particle discrete element method, and a meshless method.

The mechanical constitutive includes Drucker-Prager constitutive, Mohr-Coulomb constitutive, Hoek-Brown constitutive, ubiquitous joint constitutive, and fracture energy constitutive.

Step S2, adjusting stratum parameters, structural plane parameters and activating factor strength based on the computational model, carrying out a large amount of numerical simulation, summarizing results of the numerical simulation, normalizing input quantities and output quantities to establish machine learning samples, and randomly dividing the learning samples into a sample A for machine learning and a sample B for machine prediction.

Step S3, carrying out neural network selection and initialization settings, including determining the number of neurons at input and output terminals, determining the number of hidden layers and the number of neurons in each layer, selecting an activating function and an initial value of the weight coefficient, inputting the sample A to the neural network for learning, adjusting and optimizing transfer coefficients between neurons of the respective layers in the neural network to form a first surrogate model for slope safety prediction, and then inputting the sample B to the first surrogate model for prediction verification, and further adjusting the weight coefficient in the first surrogate model to form a second surrogate model for slope safety prediction with high reliability.

The neural network includes a forward neural network and a feedback neural network, the forward neural network includes a single-layer perceptron, multi-layer perceptron, BP neural network, and the feedback neural network includes Hopfield, Hamming, BAM network.

Step S4, based on the geomechanical parameters in the initial state, inputting the activating factor data monitored on site of the slope into the second surrogate model, calculating the deformation failure situation of the slope, comparing the surface and internal mechanical response monitoring data of the slope with the calculation data of the corresponding positions in the second surrogate model to dynamically adjust the geomechanical parameters of the respective positions in the second surrogate model; and inputting the adjusted geomechanical parameters into the second surrogate model again to calculate the deformation failure situation of the slope and the disaster process.

The geomechanical parameters include density, elastic modulus, Poisson's ratio, cohesion, internal friction angle, tensile strength, dilatancy angle, tensile fracture energy, and shear fracture energy.

The activating factor includes rainfall, reservoir water or groundwater fluctuations, earthquakes, manual excavation, and engineering blasting disturbances.

The inversion method of geomechanical parameters in slope current state includes a gradient descent method, a conjugate gradient method, and a Newton method.

Step S5, repeating step S4 to realize the dynamic assessment of future slope safety. The dynamic assessment of slope safety includes stability assessment and disaster risk assessment.

The present invention combines the on-site monitoring data, the numerical simulation analysis and the neural network prediction, creates geometric model and computational grid according to the slope type, provides samples for machine learning through a large number of numerical simulations, carries out deep learning with the help of the neural network to form the surrogate model for real-time prediction of the slope safety, carries out dynamic inversion on the geomechanical parameters in the surrogate model using the monitoring data to form accurate geomechanical input parameters of the current state, and inputs the adjusted geomechanical parameters into the surrogate model to dynamically assess the future slope safety. Compared with the conventional slope safety prediction model based only on the monitoring data, the present invention has higher prediction accuracy and is able to analyze and predict the range of the slope disaster. Compared with the conventional numerical simulation analysis, the present invention is able to dynamically adjust the geomechanical input parameters by using the monitoring data, making the prediction accuracy further higher, and can further achieve the real-time prediction due to the use of the surrogate model created by the neural network.

The present invention provides a first slope safety assessment example below.

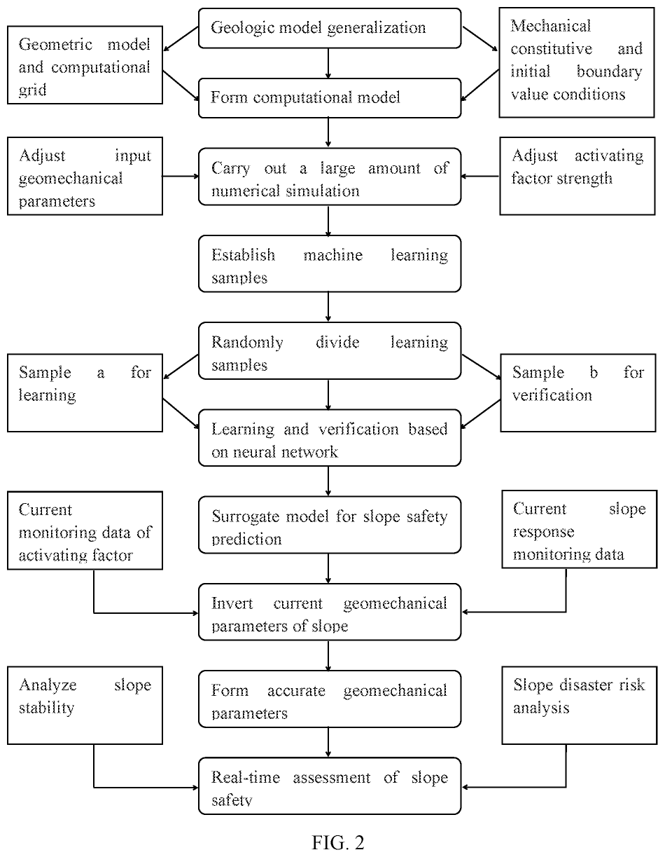

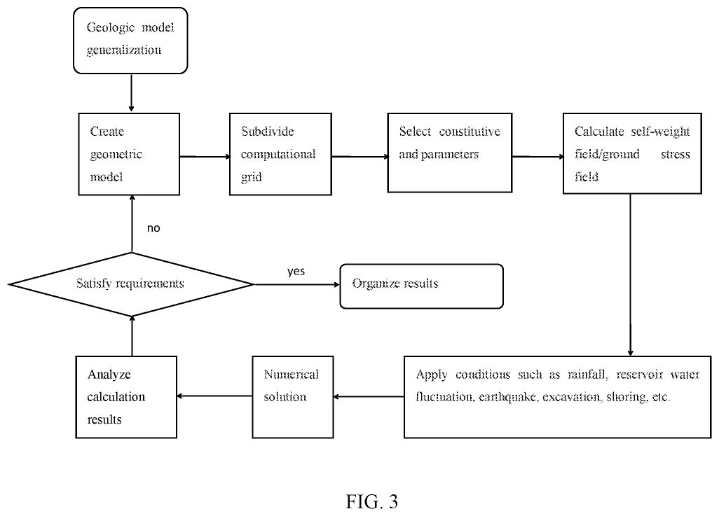

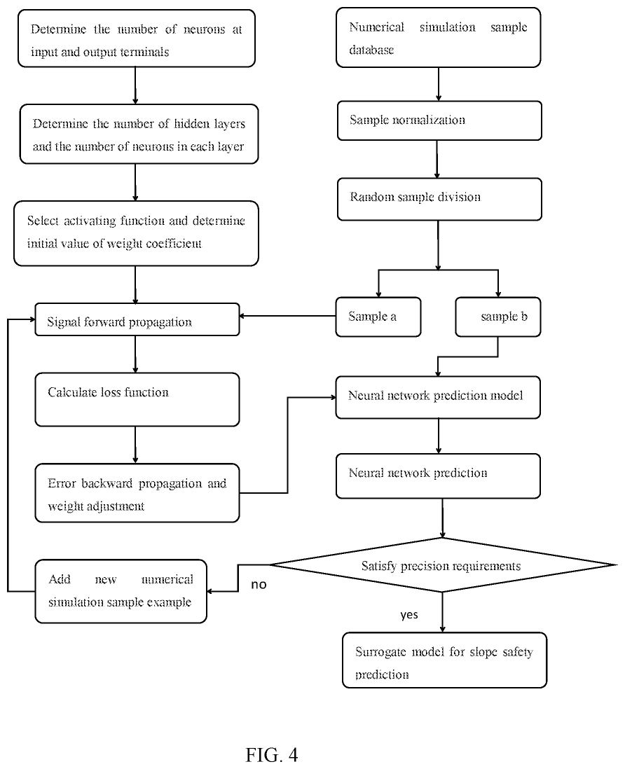

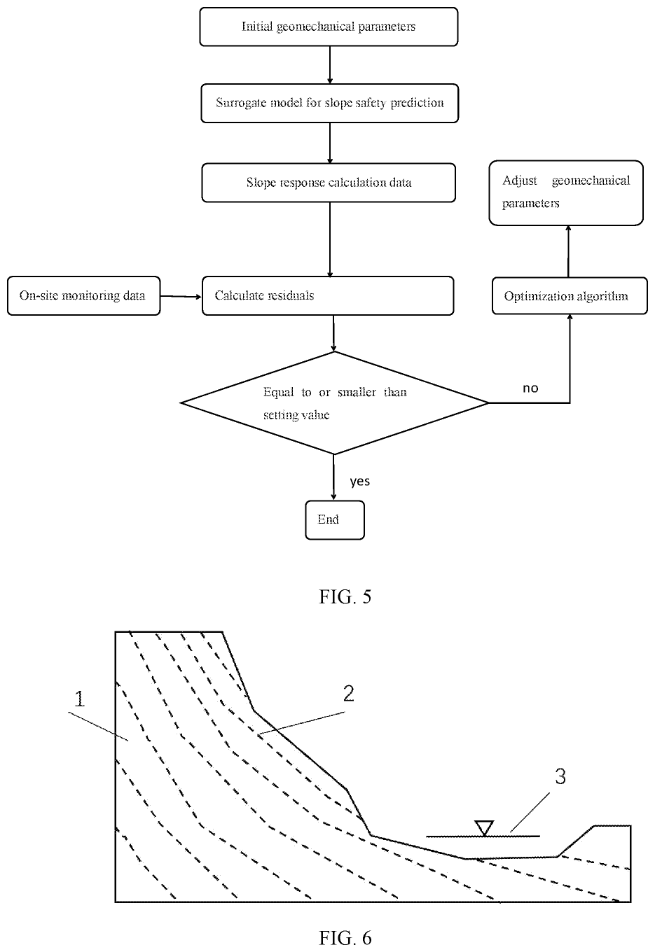

According to the flowcharts in FIG. 2-FIG. 5, the deformation failure situation of the certain slope, which has shown signs of deformation failure when the reservoir water level changes, is assessed in real time. A generalized geological model is created according to the slope type and slope structure, as shown in FIG. 6. In the figure, 1 indicates the bedding rock slope, 2 indicates the structural plane, and 3 indicates the current reservoir water level. The model has a height of 120 m and a length of 200 m. By using GDEM software, the geometric model is created and is subjected to grid subdivision, obtaining a total of 25632 triangular grids. The normal displacement constraints are imposed on the left and right sides and the bottom of the model, and the direction of gravity is vertically downward. The numerical simulation is carried out based on the continuum-discontinuum element method (CDEM), where the rock mass adopts the linear elastic constitutive and the structural plane adopts the brittle Mohr-Coulomb constitutive. The initial parameters of the rock mass include the density of 2650 kg/m3, the elastic modulus of 35 GPa, the Poisson's ratio of 0.25. The parameters of the structural plane include the normal contact stiffness per unit area of 10 GPa/m, the tangential contact stiffness per unit area of 4 GPa/m, the cohesion of 0.9 MPa, the internal friction angle of 25.6°, the tensile strength of 0.5 MPa. According to the failure characteristics of the bedding slope, the values of the cohesion, the internal friction angle and the tensile strength of the structural plane affect the deformation failure mode and the stability of the slope. While adjusting the cohesion of the structural plane to 2.0 MPa from 0.1 MPa, and the step pitch to 0.1 MPa, adjusting the tensile strength of the structural plane to 1.0 MPa from 0.1 MPa, and the step pitch to 0.1 MPa, adjusting the internal friction angle of the structural plane to 35° from 15°, and the step pitch to 1°, and adjusting the reservoir water level elevation to 2600 m from 2100 m, and the step pitch to 50 m, the numerical simulation calculation is carried out for 40,000 times to obtain the deformation failure situations of the slope under different structural plane strength parameters and different reservoir water levels. By adopting the cohesion, the internal friction angle, the tensile strength and the rising value of the reservoir water level of the structural plane as input values, and the surface displacements at three typical positions on the slope surface as output values, the input parameters and output parameters are normalized to form samples for machine learning. The BP neural network is adopted for learning, the number of neurons in the input layer is 4, the number of neurons in the output layer is 3, the hidden layer is set to 3 layers, the number of neurons is 10 each time, and the sigmoid function is selected as the activating function. The 40,000 samples are randomly divided into 2 groups, including 35,000 samples as the group A for machine learning and 5,000 samples as the group B for verification. After the machine learning and the sample verification, a prediction surrogate mode for slope safety with the required accuracy is created to carry out deformation prediction of the rock slope. By inputting the water level change data obtained by the on-site monitoring into the surrogate model, calculating the displacement changes of the three monitoring points on the slope surface with surrogate model the in real time, comparing them with the displacements at the corresponding positions obtained by the on-site monitoring, using the two-norm of the difference between the calculated displacement and the actual displacement as the optimization target, and adopting the conjugate gradient method for optimization, after 1200 iterations, the structural plane strength parameters of the bedding rock slope that best match the on-site monitoring data are found out. That is, the cohesion is 0.73 MPa, the internal friction angle is 28.2°, and the tensile strength is 0.24 MPa. By inputting the optimized and adjusted strength parameters and the change parameters of the future water level into the surrogate model, the real-time prediction of the impact of the water level change on the stability of the bedding rock slope is carried out.

The present invention provides the second slope safety assessment example as follows.

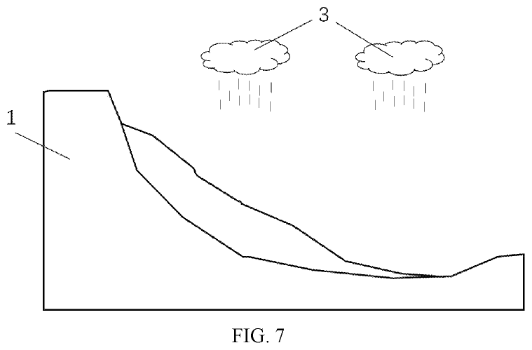

The safety of a bedrock and overburden slope, which has undergone continuous deformation due to the rainfall, is assessed in real time according to the flowcharts in FIG. 2-FIG. 5. According to the slope type and rock layer characteristics, a geological model is generalized, as shown in FIG. 7, where 1 indicates bedrock, 2 indicates overburden, and 3 indicates rainfall. By using GDEM software, the geometric model is created and is subjected to grid subdivision, obtaining a total of 12865 triangular elements. The normal displacement constraints are imposed on the left and right sides and the bottom of the model, and the direction of gravity is vertically downward. The numerical simulation is carried out based on the finite element method that can calculate the seepage-stress coupling effect and the water absorption weakening effect of the overburden, where the bedrock adopts the linear elastic constitutive and the overburden adopts the Mohr-Coulomb constitutive having water absorption softening effect. The geomechanical parameters of bedrock include the density of 2450 kg/m3, the elastic modulus of 15 GPa, the Poisson's ratio of 0.26. The geomechanical parameters of the overburden include the density of 2100 kg/m3, the elastic modulus of 1 GPa, the Poisson's ratio of 0.33, the cohesion of 50 kPa, the internal friction angle of 23°, the tensile strength of 20 kPa, the dilatancy angle of 15°, the porosity of 0.1, the permeability coefficient of 0.02 cm/s, the characteristic water absorption time of the overburden of 1 day, the modulus water absorption weakening coefficient of 0.8, and the strength water absorption weakening coefficient of 0.5. Since the basic geomechanical parameters of the overburden have been well understood in the previous investigation, five parameters including the rainfall intensity, the rainfall duration, the characteristic water absorption time of the overburden, the modulus water absorption weakening coefficient, and the strength water absorption weakening coefficient are selected as adjustment parameters, and each factor is adjusted to 5 levels, obtaining a total of 3125 examples for calculation. After the calculation of the examples is completed, the data of each group of examples is normalized and randomly divided into two groups, including 90% as a group A for machine learning and 10% as a group B for verification. The BP neural network is selected for learning, the number of neurons in the input layer is 5, the number of neurons in the output layer is 5, the hidden layer is set to 4 layers, the number of neurons is 8 each time, and the tanh function is selected as the activating function. After the machine learning and the sample verification, a prediction surrogate mode for slope safety with the required accuracy is created to carry out deformation prediction of the bedrock and overburden slope. By inputting the initial material parameters into the surrogate model for calculation, calculating the displacement values of the five monitoring points, comparing them with the actual values on site, using the two-norm of the difference between the calculated displacement and the actual displacement as the optimization target, and adopting the Newton iteration method for optimization, after 2630 iterations, the optimization parameters of the bedrock and overburden slope that best match the site monitoring data are found out. That is, the characteristic water absorption time of the overburden is 2.3 days, the modulus water absorption weakening coefficient is 0.89, and the strength water absorption weakening coefficient is 0.34. By inputting the optimized and adjusted parameters and possible future rainfall parameters into the surrogate model, the real-time prediction of the impact of rainfall on the stability and deformation failure of the bedrock and overburden slope is carried out.

The above embodiments are merely exemplary embodiments of the present application, which are not intended to limit the present application, and the protection scope of the present application is defined by the claims. Various modifications or equivalent substitutions that would be made by those skilled in the art without departing from the spirit and protection scope of the present application, shall fall within the protection scope of the present invention.

What is claimed is:

1. A method for dynamically assessing a slope safety, comprising:
step S1, carrying out geologic model generalization to a slope according to a slope type, a slope structure, stratum characteristics and a deformation failure mode to obtain a slope geologic model, creating a slope geometric model according to the slope geologic model, carrying out a subdivision of computational grid, and selecting a reasonable numerical simulation method, a mechanical constitutive and initial boundary value conditions to form a computational model;
step S2, adjusting stratum parameters, structural plane parameters and activating factor strength based on the computational model, carrying out a large amount of numerical simulation, summarizing results of a numerical simulation, normalizing input quantities and output quantities to establish machine learning samples, and randomly dividing the machine learning samples into a first sample for machine learning and a second sample for machine prediction;
step S3, carrying out neural network selection and initialization settings, comprising determining a number of neurons at input and output terminals, determining a number of hidden layers and a number of neurons in each layer, selecting an activating function and an initial value of a weight coefficient, inputting the first sample to a neural network for learning, adjusting and optimizing transfer coefficients between neurons of respective layers in the neural network to form a first surrogate model for a slope safety prediction, and then inputting the second sample to the first surrogate model for prediction verification, and further adjusting the weight coefficient in the first surrogate model to form a second surrogate model for the slope safety prediction with high reliability;
step S4 based on geomechanical parameters in an initial state, inputting activating factor data monitored on site of the slope into the second surrogate model, calculating a deformation failure situation of the slope, comparing surface and internal mechanical response monitoring data of the slope with calculation data of corresponding positions in the second surrogate model to dynamically adjust the geomechanical parameters of respective positions in the second surrogate model to obtain adjusted geomechanical parameters; and inputting the adjusted geomechanical parameters into the second surrogate model again to calculate the deformation failure situation of the slope and a disaster process; and
step S5, repeating step S4 to realize a dynamic assessment of future slope safety.

2. The method for dynamically assessing the slope safety according to claim 1, wherein
the slope type comprises rocky slope, soil slope, and bedrock and overburden slope; the slope structure comprises a bedding structure, an anti-dip structure, a blocky structure, a loose structure, and a soil-rock mixture structure; and the deformation failure mode comprises slipping landslide, toppling failure, and collapse failure.

3. The method for dynamically assessing the slope safety according to claim 1, wherein
the computational grid comprises two-dimensional triangle, quadrilateral, polygon and disk grids, and three-dimensional tetrahedron, triangular prism, pyramid, hexahedron, polyhedron, and sphere grids.

4. The method for dynamically assessing the slope safety according to claim 1, wherein
the reasonable numerical simulation method comprises a finite element method, a finite volume method, a finite difference method, a block discrete element method, a particle discrete element method, and a meshless method.

5. The method for dynamically assessing the slope safety according to claim 1, wherein
the mechanical constitutive comprises Drucker-Prager constitutive, Mohr-Coulomb constitutive, Hoek-Brown constitutive, ubiquitous joint constitutive, and fracture energy constitutive.

6. The method for dynamically assessing the slope safety according to claim 1, wherein
the geomechanical parameters comprise density, elastic modulus, Poisson's ratio, cohesion, internal friction angle, tensile strength, dilatancy angle, tensile fracture energy, and shear fracture energy.

7. The method for dynamically assessing the slope safety according to claim 1, wherein
the neural network comprises a forward neural network and a feedback neural network, wherein the forward neural network comprises a single-layer perceptron, multi-layer perceptron, back propagation (BP) neural network, and the feedback neural network comprises Hopfield, Hamming, Bidirectional Associative Memory (BAM) network.

8. The method for dynamically assessing the slope safety according to claim 1, wherein
the activating factor comprises rainfall, reservoir water or groundwater fluctuations, earthquakes, manual excavation, and engineering blasting disturbances.

9. The method for dynamically assessing the lope safety according to claim 1, wherein
the dynamic assessment of the slope safety comprises stability assessment and disaster risk assessment.

10. The method for dynamically assessing slope safety according to claim 1, wherein
an inversion method of the geomechanical parameters in a slope current state comprises a gradient descent method, a conjugate gradient method, and a Newton method.
